(19) United States
(12) Patent Application Publication
(10) Pub. No.: US 2026/0126131 A1
(43) Pub. Date: May 7, 2026

(54) A PIPE JACKING MACHINE

(71) Applicant: HK CK DEVELOPMENT LIMITED, Hong Kong (CN)

(72) Inventor: Lung Wong, Hong Kong (CN)

(21) Appl. No.: 19/371,454

(22) Filed: Oct. 28, 2025

(30) Foreign Application Priority Data
Nov. 6, 2024 (HK) 32024099138.2

(51) Int. Cl. F16L 1/028; E02F 5/18

(52) U.S. Cl. CPC F16L 1/028; E02F 5/18

(57) ABSTRACT

A pipe jacking machine, comprising a flange for connecting the rear section of the locomotive part, a housing, and pipes; one end of the housing is connected to the flange and the other end is connected to said pipe; a first shield tail brush is provided surrounding outside of the housing at the end close to the flange. By providing the first shield tail brush on the outside of the housing, the first shield tail brush effectively prevents rock fragments cut by the cutter disk from falling into the outer wall space behind the pipe, thereby preventing the accumulation of spoil and avoiding impacts on the construction; the configuration not only ensures the normal operation of the equipment and extends the service life of the equipment.

### FIELD OF THE INVENTION

The invention relates to the technical field of pipeline excavation engineering equipment, specifically a pipe jacking machine.

### BACKGROUND OF THE INVENTION

With the continuous advancement in pipeline construction, the demands for crossing challenging areas such as highways, railways, and complex building clusters have become increasingly urgent. Historically, pipe jacking construction methods relying on manual excavation have gradually been phased out due to their susceptibility to collapse accidents, low construction efficiency, and high environmental sensitivity. Against this backdrop, pipe jacking technology, with its unique advantages, plays a crucial role in trenchless crossing construction.

As the core equipment for construction, a pipe jacking machine typically consists of components such as a cutter disc, a cutter housing, a power unit, a muck removal device, and a steering/correction device. During operation, the pipe jacking machine first utilizes a power unit, located within the cutter housing, to drive the cutter disc and excavate the tunnel. Subsequently, the excavated soil or slurry is discharged from the tunnel via the muck removal device. Next, tunnel segments are installed within the newly advanced tunnel. This cycle repeats until the pipe jacking machine successfully advances from the launching shaft to the receiving shaft.

However, in actual application, pipe jacking machines have also exposed some problems. Due to the design characteristic where the locomotive part's diameter exceeds the pipe diameter, coupled with the unavoidable gap between the pipe wall and the excavated tunnel wall, rock fragments cut by the locomotive part often fall into the annular space behind the pipe during construction, leading to the accumulation of spoil. This not only increases the risk of the pipe getting jammed by rock fragments/spoil, pipe locking/seizure, and increased jacking force, but also leads to significant loss of lubrication slurry in downward sloping straight sections. This severely impairs the drag reduction effect and can even result in the failure of the pipe jacking operation.

### SUMMARY OF THE INVENTION

The present invention provides a pipe jacking machine configured to effectively block rock fragments and spoil, avoiding their accumulation in the annular space behind the pipe, and thus ensuring the smooth execution of construction.

The invention introduces a pipe jacking machine, comprising:
a flange for connecting to a rear section of the locomotive part,
a housing, and
pipe;
one end of the housing is connected to the flange and the other end is connected to said pipe; a first shield tail brush is provided surrounding outside of the housing at the end close to the flange.

Preferably, a drive cylinder for driving a cutter disc forward is disposed within the housing, one end of the drive cylinder is connected to the flange, and the other end bears against the pipe, the flange is configured to be driven by the drive cylinder to extend and retract relative to the housing.

Preferably, the housing is a tubular body divided into a first pipe section and a second pipe section, one end of the first pipe section is connected to the flange, and the other end is connected to the second pipe section; the second pipe section is sleeved over the outside of the pipe, the first shield tail brush is surrounding the exterior of the first pipe section.

Preferably, the inner wall of the second pipe section is provided with a sealing assembly, the sealing assembly comprises a second shield tail brush circumferentially and evenly arranged the connection portion between the second pipe section and the pipe.

Preferably, reinforcing ribs are provided between the connection of the first pipe section and the second pipe section.

Preferably, the diameter of the first pipe section is smaller than that of the second pipe section, and a stepped transition is provided between the connection of the first pipe section and the second pipe section, the reinforcing ribs are divided into outer reinforcing ribs and inner reinforcing ribs; the outer reinforcing ribs are located on the outer side of the first pipe section and are connected respectively to the first pipe section and the stepped transition, forming a supporting part, the inner reinforcing ribs are located on the inner side of the second pipe section and are connected respectively to the second pipe section and the stepped transition, forming another supporting part.

Preferably, a sealing ring is circumferentially arranged on the inner wall of the second pipe section.

Preferably, a supporting ring is provided the inner wall of the second pipe section for supporting the pipe.

Preferably, the supporting ring is divided into a full supporting ring and a half supporting ring, the full supporting ring is arranged on the inner wall of the second pipe section, the half supporting ring is located on the lower inner wall of the second pipe section to support the bottom of the pipe.

Preferably, the flange is provided with an internal cavity, within which uniformly distributed supporting reinforcing ribs are arranged.

Preferably, a groove for installing a waterproof rubber ring is set on the outer annular surface of the flange.

The present invention has the following beneficial effects:
(1) The present invention, by providing a first tail brush on the outer side of the housing, enables the first tail brush to effectively block rock fragments cut by the cutter disc from falling into the annular space behind the pipe, thereby preventing the accumulation of spoil which could impact construction. Such a configuration not only protects the normal operation of the equipment but also extends its service life.
(2) The internal drive cylinders within the housing can drive the cutter disc to apply additional thrust for forward displacement, thereby further improving construction efficiency.
(3) By providing a second tail brush positioned between the connection of the second pipe section and the pipe, sealing performance is further enhanced, effectively preventing spoil and other debris from entering the interior of the housing through the gap between the pipe and the housing, thereby reducing the probability of equipment malfunction.
(4) The reinforcing ribs located between the connection of the first pipe section and the second pipe section significantly improve the overall strength and stability of the housing. Specifically, the outer reinforcing ribs and inner reinforcing ribs respectively form supporting part on the outer and inner sides, which effectively dissipate external forces during the construction process, thereby reducing the risk of damage to the housing.

### BRIEF DESCRIPTION OF THE DRAWINGS

FIG. 1 is a schematic structural diagram of the present invention.

FIG. 2 is a cross-sectional schematic diagram of the structure of the present invention.

FIG. 3 is a schematic diagram of the connection structure between the housing and the pipe in the present invention.

FIG. 4 is a partially enlarged schematic diagram of section “A” in FIG. 2.

In the above drawings, 1. flange, 2. housing, 3. pipe, 4. first shield tail brush, 5. drive cylinder, 6. first pipe section, 7. second pipe section, 8. second shield tail brush, 9. reinforcing rib, 10. stepped transition, 11. outer reinforcing rib, 12. inner reinforcing rib, 13. sealing ring, 14. support ring, 15. full support ring, 16. half support ring, 17. supporting reinforcing rib.

### DESCRIPTION OF THE EMBODIMENTS

Hereinafter, the inventive concept, specific structure, and technical effects produced by this utility model will be clearly and completely described in conjunction with the embodiments and accompanying drawings, in order to fully understand the objectives, solutions, and effects of this utility model. It should be noted that, without conflict, the embodiments and features within the embodiments in this application may be combined with each other.

It should be noted that, unless otherwise specified, when a feature is referred to as being “fixed” or “connected” to another feature, it can be directly fixed or connected to the other feature, or it can be indirectly fixed or connected to the other feature. Furthermore, descriptions such as upper, lower, left, right, top, and bottom used in this utility model are merely relative to the positional relationships between the various components of this utility model in the accompanying drawings.

Furthermore, unless otherwise defined, all technical and scientific terms used herein have the same meaning as commonly understood by one of ordinary skill in the art to which this utility model belongs. The terminology used in the specification herein is for the purpose of describing particular embodiments only and is not intended to be limiting of this utility model. As used herein, the term “and/or” includes any and all combinations of one or more of the associated listed items.

It should be understood that, although in this disclosure terms such as first, second, third, etc., may be used to describe various elements, these elements should not be limited by these terms. These terms are only used to distinguish elements of the same type from each other. For example, without departing from the scope of this disclosure, a first element could also be referred to as a second element, and similarly, a second element could also be referred to as a first element.

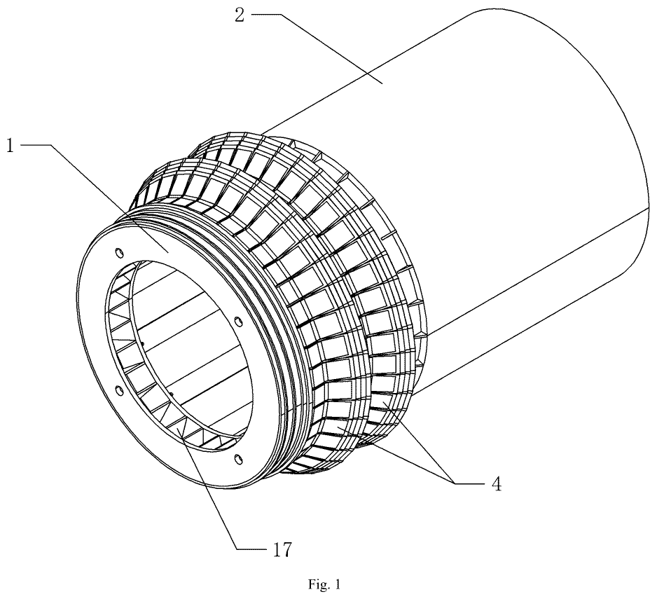

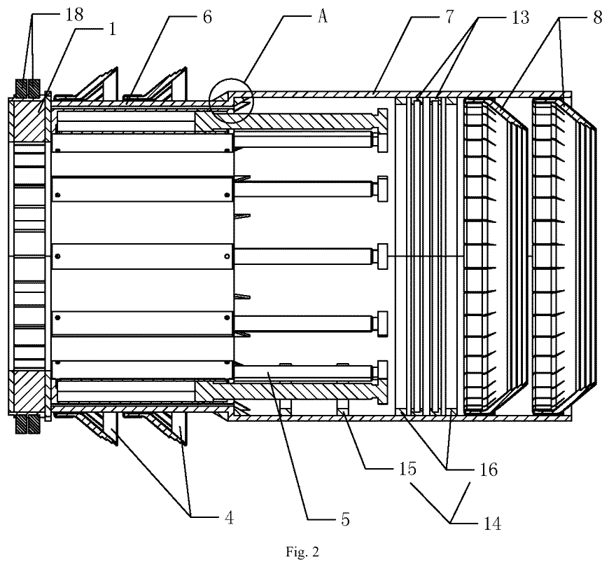

As shown in FIGS. 1 and 2, the present invention provides a pipe jacking machine, comprising a flange 1 for connecting the rear section of the locomotive part, a housing 2, and a pipe 3. One end of the housing 2 is connected to the flange 1, and the other end is connected to the pipe 3. The housing 2 is circumferentially provided with a first shield tail brush 4 on the outer side near the locomotive part. Specifically, a rotatable cutter disc is mounted on the flange 1, which, driven by a propulsion device (such as the drive cylinder 5), performs forward propulsion and rotational cutting of rock and soil. As the cutter disc cuts and advances, rock and soil are broken into small fragments. During this process, the first shield tail brush 4 is circumferentially provided on the outer side of the housing 2 near the locomotive part. When rock fragments splash backward, the first shield tail brush 4 acts like a barrier, utilizing the elasticity of bristles and tightly arranged structure to effectively block rock fragments from moving further backward. As the pipe jacking machine advances, the first shield tail brush 4 continuously pushes rock fragments to fall into a preset channel device, such as the mucking device connected to the cutter disc, and transport to the outside for preventing from falling into the annular space behind the pipe 3 and causing accumulation which ensures that spoil and other materials are discharged through the preset channel, thereby guaranteeing smooth construction operations.

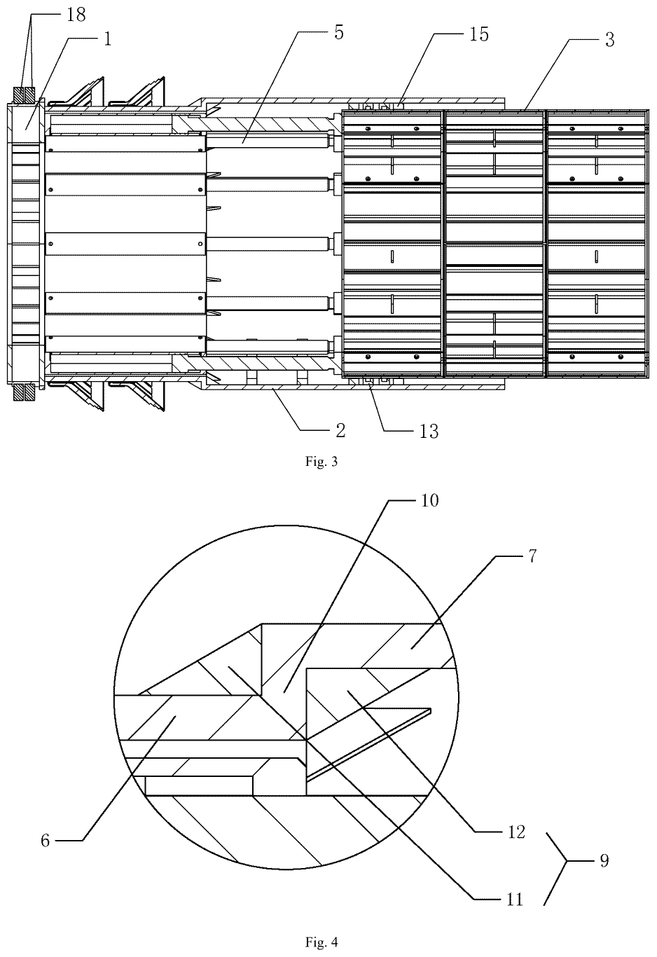

As shown in FIG. 2 and FIG. 3, the aforementioned drive method for advancing the cutter disc is preferably a drive cylinder 5. The drive cylinder 5, which is used for displacing the cutter disc forward, is installed inside the housing 2. One end of the drive cylinder 5 is fixedly connected to the flange 1, while the other end bears against the pipe 3. The flange 1 is driven by the drive cylinder 5 to extend and retract relative to the housing 2. Specifically, the drive cylinder 5 serves as a power source for the pipe jacking machine. During operation, high-pressure hydraulic fluid is injected into the drive cylinder 5 through a hydraulic system. The pressure of the high-pressure hydraulic fluid acts on the piston of the drive cylinder 5, causing the piston to move either forward or backward. Since one end of the drive cylinder 5 is fixedly connected to the flange 1, when the piston moves forward, it pushes the flange 1 forward, which in turn drives the cutter disc mounted on the flange 1 to advance, thereby achieving the cutting and propulsion through rock and soil. When it is necessary to adjust the cutter disc's position, retract it, or advance the rear pipe 3, the hydraulic system controls the flow direction of the hydraulic fluid, causing the piston to move backward. This, in turn, pulls the flange 1 to retract relative to the housing 2. The drive cylinder 5 can precisely control the forward and backward telescopic movement of the flange 1, thereby allowing the cutting depth and advancement speed of the cutter disc to be adjusted according to various geological conditions and construction requirements. This makes the construction process more flexible and controllable, improving both construction precision and quality. Furthermore, when encountering hard rock or complex geological structures, the drive cylinder 5 can provide sufficient thrust, enabling the cutter disc to cut and advance smoothly. For instance, when encountering excessive resistance, the drive cylinder 5 can automatically adjust its thrust, preventing equipment damage due to overload.

Preferably, the housing 2 is divided into a first pipe section 6 and a second pipe section 7. One end of the first pipe section 6 is connected to the cutter disc, and the other end is connected to the second pipe section 7. The second pipe section 7 is sleeved over the outside of the pipe 3. The first shield tail brush 4 is circumferentially and evenly arranged on the outer side of the first pipe section 6. Specifically, the first pipe section 6 serves to connect with the cutter disc and bear the cutting forces, while the second pipe section 7 provides protection and support for the pipe 3. Such design enhances the overall performance of the equipment.

As shown in FIG. 2, during the operation of the pipe jacking machine, a certain gap exists between the connection of the second pipe section 7 and the pipe 3, which could allow substances such as soil, sand, gravel, and groundwater to enter this gap. So, a sealing assembly is provided on the inner wall of the second pipe section 7. This sealing assembly includes a second shield tail brush 8, which is circumferentially and evenly arranged between the second pipe section 7 and the pipe 3 at the connection point, thereby fulfilling its sealing function. Specifically, the bristles of the second shield tail brush 8 tightly surround the outer side of the pipe 3. When external substances attempt to enter the gap, the bristles serve as a sealing barrier to prevent ingress. Furthermore, due to the inherent elasticity of the bristles, they can adapt to slight wobbling and displacement of the pipe 3 during its advancement, consistently maintaining a good sealing effect. This enhances the sealing performance, effectively preventing external substances like soil, sand, gravel, and groundwater from entering the gap and avoids potential negative impacts on the normal operation of the pipe jacking machine due to the ingress of external substances, such as blocking the pipe 3 or damaging the equipment.

As shown in FIG. 1, FIG. 2, and FIG. 4, preferably, during the operation of the pipe jacking machine, significant pressure and stress are exerted on the housing 2 due to the cutting action of the cutter disc and various forces generated during the advancement of the pipe 3. Reinforcing ribs 9 are circumferentially and evenly arranged between the connection of the first pipe section 6 and the second pipe section 7, serving to enhance the structural strength of the housing 2. Specifically, when external forces applied upon the housing 2, the reinforcing ribs 9 bear a portion of the stress. The distribution of the reinforcing ribs 9 allows stress to be more evenly dispersed across various parts, preventing localized stress concentrations. The reinforcing ribs 9 themselves possess high strength and rigidity, enabling them to withstand significant tensile, compressive, and bending forces. When subjected to external forces, the reinforcing ribs 9 are slightly deformed but do not easily fracture or get damaged. In this manner, the reinforcing ribs 9 collaborate with the first pipe section 6 and the second pipe section 7, thereby enhancing the overall stability and deformation resistance of the housing 2.

As shown in FIG. 4, further, the diameter of the first pipe section 6 is smaller than that of the second pipe section 7, and a stepped transition 10 is provided between their connection. The reinforcing ribs 9 are divided into outer reinforcing ribs 11 and inner reinforcing ribs 12. The outer reinforcing ribs 11 are positioned on the outer side of the first pipe section 6 and are connected to both the first pipe section 6 and the stepped transition 10, forming a supporting surface. When external forces act on the equipment, the outer reinforcing ribs 11 first bear a portion of the external pressure and tension. The outer reinforcing ribs 11 are tightly connected to the first pipe section 6 and the stepped transition 10, effectively dispersing and transferring the received forces to the first pipe section 6 and the stepped transition 10. This arrangement enhances the strength of the first pipe section 6 at its connection point, preventing it from deforming or being damaged due to external forces.

Simultaneously, the inner reinforcing ribs 12 are positioned on the inner side of the second pipe section 7 and are connected to both the second pipe section 7 and the stepped transition 10, forming a supporting surface. When the equipment is subjected to internal pressure or other forces, the inner reinforcing ribs 12 provide support. The inner reinforcing ribs 12, connected to the second pipe section 7 and the stepped transition 10, form a supporting surface capable of withstanding internal pressure and impact forces, and transmitting these forces to the second pipe section 7 and the stepped transition 10. This consequently enhances the stability of the second pipe section 7 at its connection point.

The stepped transition 10 is a critical part for the connection of the first pipe section 6 and the second pipe section 7, and is consequently prone to significant stress concentration. The outer reinforcing ribs 11 and inner reinforcing ribs 12 are respectively connected to the stepped transition 10, forming supporting surfaces. This arrangement greatly enhances the strength of the connection point, effectively preventing it from fracturing or loosening when subjected to forces, thereby ensuring the reliability of the equipment.

As shown in FIG. 2 and FIG. 3, due to a certain gap existing between the connection of the pipe 3 and the second pipe section 7, a sealing ring 13 is circumferentially arranged on the inner wall of the second pipe section 7, tightly fitting and filling the space between the pipe 3 and the second pipe section 7. The sealing ring 13 can comprise multiple rings as per actual conditions. When foreign objects (such as soil, groundwater, etc.) attempt to enter from the gap between the second pipe section 7 and the pipe 3, the sealing ring 13 can effectively prevent such invasion, forming a reliable sealing barrier. The sealing ring 13 is typically made of elastic and sealing materials, such as rubber. Its elasticity enables the sealing ring 13 to adapt to slight wobbling and displacement of the pipe 3 during its advancement, consistently maintaining tight contact with the outer surface of the pipe 3.

As shown in FIG. 2 and FIG. 3, the inner wall of the second pipe section 7 is provided with support rings 14 designed to support pipe 3. These support rings 14 are used to bear the weight of pipe 3 as well as various forces generated during the jacking process. Several support rings 14 can be provided and the number depends on actual circumstances. The support rings 14 are uniformly distributed on the inner wall of the second pipe section 7, enabling pipe 3 to maintain a stable position during the jacking process and prevent from sinking, shifting, or experiencing other deviations due to gravity or other external forces. Furthermore, during the jacking process of pipe 3, friction is generated between the support rings 14 and pipe 3. To reduce the friction, the surface of the support rings 14 can also apply special treatment, such as using smooth materials or adding a lubricating coating, to ensure that pipe 3 can slide smoothly on the support rings 14.

Preferably, the support rings 14 are divided into full support rings 15 and half support rings 16. The full support rings 15 are arranged circumferentially on the inner wall of the second pipe section 7, establishing extensive contact with the outer surface of pipe 3 and providing all-around support for pipe 3. The full support rings 15 can uniformly distribute the weight of pipe 3, preventing pipe 3 from swaying or shifting horizontally. Concurrently, the full support rings 15 also restrict the radial movement of pipe 3, ensuring that pipe 3 always maintains its coaxial alignment with the housing 2.

The half support rings 16 are positioned on the inner wall at the lower portion of the second pipe section 7, primarily serving to support the bottom of pipe 3. As pipe 3 is subjected to gravity, the bottom of pipe 3 which is connected to the housing 2, experiences significant pressure. The half support rings 16 are thus specifically designed to provide additional support to the bottom of pipe 3, effectively preventing it from deforming or being damaged due to excessive stress. Concurrently, the half support rings 16 and the full support rings 15 work in conjunction to jointly maintain the stability of pipe 3.

As shown in FIG. 1, when the pipe jacking machine is operating, the cutter disc on the flange 1 performs tasks such as rotary cutting of rock and soil, enduring immense forces from various directions. The flange 1 is internally equipped with a cavity, within which support ribs 17 are uniformly distributed. When the cutter disc cuts rock and soil, the resulting reaction forces are transmitted to the flange 1. These support ribs 17 are capable of uniformly distributing these forces throughout the entire structure of the flange 1. Due to their uniform distribution, the support ribs 17 can withstand and transmit these forces from various angles and positions, thereby preventing excessive localized stress that could lead to deformation or damage of the flange 1. Furthermore, the support ribs 17 are high strength and rigidity, enabling them to resist various stresses such as compression, tension, and bending. While subjected to external forces, the support ribs 17 might undergo minor deformation, but they will not easily break or lose their supporting function. In this way, the cooperative action of the support ribs 17 and the flange 1 significantly enhances the overall stability and deformation resistance of the flange 1. To prevent water used for cutter disc excavation from entering the outer wall behind the flange 1, a groove for installing a waterproof seal ring 18 is provided on the outer annular surface of the flange 1. The installation of this waterproof ring 18 ensures a sealing effect against water.

The foregoing description merely presents a preferred embodiment of the present invention, and the present invention is not limited to the embodiments described above. As long as they achieve the technical effects of the present invention through equivalent means, any modifications, equivalent substitutions, or improvements made within the spirit and principles of this disclosure shall fall within the scope of protection of the present invention. Within the scope of protection of the present invention, its technical solutions and/or embodiments may be subject to various modifications and variations.

1. A pipe jacking machine, comprising:
a flange, for connecting to a rear section of the locomotive part,
a housing, and
pipe;
one end of the housing is connected to the flange and the other end is connected to said pipe; a first shield tail brush is provided surrounding outside of the housing at the end close to the flange.

2. The pipe jacking machine of claim 1, wherein a drive cylinder for driving a cutter disc forward is disposed within the housing, one end of the drive cylinder is connected to the flange, and the other end bears against the pipe, the flange is configured to be driven by the drive cylinder to extend and retract relative to the housing.

3. The pipe jacking machine of claim 1, wherein the housing is a tubular body divided into a first pipe section and a second pipe section, one end of the first pipe section is connected to the flange, and the other end is connected to the second pipe section; the second pipe section is sleeved over the outside of the pipe, the first shield tail brush is surrounding the exterior of the first pipe section.

4. The pipe jacking machine of claim 3, wherein the inner wall of the second pipe section is provided with a sealing assembly, the sealing assembly comprises a second shield tail brush circumferentially and evenly arranged at the connection portion between the second pipe section and the pipe.

5. The pipe jacking machine of claim 3, wherein reinforcing ribs are provided between the connection of the first pipe section and the second pipe section.

6. The pipe jacking machine of claim 5, wherein the diameter of the first pipe section is smaller than that of the second pipe section, and a stepped transition is provided between the connection of the first pipe section and the second pipe section, the reinforcing ribs are divided into outer reinforcing ribs and inner reinforcing ribs; the outer reinforcing ribs are located on the outer side of the first pipe section and are connected respectively to the first pipe section and the stepped transition, forming a supporting part, the inner reinforcing ribs are located on the inner side of the second pipe section and are connected respectively to the second pipe section and the stepped transition, forming another supporting part.

7. The pipe jacking machine of claim 3, wherein a sealing ring is circumferentially arranged on the inner wall of the second pipe section.

8. The pipe jacking machine of claim 3, wherein a supporting ring is provided on the inner wall of the second pipe section for supporting the pipe.

9. The pipe jacking machine of claim 8, wherein the supporting ring is divided into a full supporting ring and a half supporting ring, the full supporting ring is arranged on the inner wall of the second pipe section, the half supporting ring is located on the lower inner wall of the second pipe section to support the bottom of the pipe.

10. The pipe jacking machine of claim 1, wherein the flange is provided with an internal cavity, within which uniformly distributed supporting reinforcing ribs are arranged.

11. The pipe jacking machine of claim 1, wherein a groove for installing a waterproof rubber ring is set on the outer annular surface of the flange.
